(19) United States
(12) Patent Application Publication
(10) Pub. No.: US 2021/0110363 A1
(43) Pub. Date: Apr. 15, 2021

(54) SYSTEMS AND METHODS FOR AUTOMATICALLY CONFIGURING A TRANSACTION SYSTEM

(71) Applicant: The Toronto-Dominion Bank, Toronto (CA)

(72) Inventors: Christopher Mark JONES, Villanova, PA (US); John William THOMAS, Kennett Square, PA (US); Marc CHALIFOUX, Toronto (CA); Jonathan Joseph PRENDERGAST, West Chester, PA (US); Michael Thomas DELAVEAGA, Newark, DE (US); Mohammad Fahad KHAN, Mississauga (CA)

(73) Assignee: The Toronto-Dominion Bank, Toronto (CA)

(21) Appl. No.: 16/597,121

(22) Filed: Oct. 9, 2019

(51) Int. Cl. G06Q 20/10; G06Q 20/32

(52) U.S. Cl. CPC G06Q 20/102; G06Q 20/3223; G06Q 20/108

(57) ABSTRACT

Computer-implemented methods for automatically identifying and configuring transfer targets in a transaction system are disclosed. Such a method may include: identifying a location associated with a first account. The first account may be associated with an account holder. A set of known transfer targets associated with the identified location is identified. Based on transaction data for one or more accounts associated with the account holder, a processor identifies transactions involving the transfer targets. One or more transactions involving a particular one of the transfer targets may be determined to correspond to one or more transfers to the particular one of the transfer targets. A prompt for presentation by a client device to add the particular one of the transfer targets to a transfer interface may then be generated. Related systems and computer-readable media are also disclosed.

### FIELD

This relates to transaction systems and, more particularly, to automatic configuration of transaction systems.

### BACKGROUND

In some transaction systems, transactions corresponding to transfers between accounts may be performed such as, for example, to transfer value from one account to another. Such transactions may be initiated from the transaction system directly or from another transaction system in communication therewith.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is high-level schematic diagram of a server computing device;

FIG. 3 shows a simplified organization of software components stored in a memory of the server computing device of FIG. 2;

FIG. 4 is a flowchart showing operations performed by the server computing device of FIG. 2 in automatically configuring a transaction system; and

FIG. 5 shows an example user interface for obtaining confirmation of automatic configuration in a transfer interface of a transaction system.

Like reference numerals are used in the drawings to denote like elements and features.

### DETAILED DESCRIPTION OF EXAMPLE EMBODIMENTS

Transactions corresponding to transfers may be performed responsive to initiation thereof. For example, transfers may be initiated responsive to user-input received via a computing device. In order to initiate transfers from a given source to particular targets or destinations using a transaction system, the transaction system may need to be configured for transferring to those targets. Existing transfer systems can rely on manual configuration which may be burdensome and/or error-prone.

According to the subject matter of the present application, there may be provided a computer system. The computer system may include a processor and a memory coupled to the processor. The memory may store instructions that, when executed by the processor, cause the computer system to: identify a location associated with a first account, the first account associated with an account holder; identify a set of transfer targets associated with the identified location; identify, based on transaction data for one or more accounts associated with the account holder, transactions involving the transfer targets; determine that one or more transactions involving a particular one of the transfer targets correspond to one or more transfers to the particular one of the transfer targets; and generate a prompt for presentation by a client device to add the particular one of the transfer targets to a transfer interface.

Conveniently, in this way, a transaction system may be automatically configured for transfers to a transfer target identified based on transaction data. Such transaction data may be obtained from other transaction systems and/or may correspond to transfers involving the transaction system but initiated by another, co-operating transaction system. Put another way, some or all of the transaction data may correspond to transactions such as may correspond to transfers that were not initiated using the transaction system.

In some implementations, determining that one or more transactions involving the particular one of the transfer targets corresponds to one or more transfers to the particular one of the transfer targets may include: computing a likelihood score based on the one or more transactions involving the particular one of the transfer targets, the likelihood score corresponding to a confidence that the one or more transactions correspond to one or more transfers to the particular one of the transfer targets; and comparing the likelihood score to a confidence threshold. For example, the likelihood score may be computed based on an evaluation of the one or more transactions according to one or more factors including a determination as to whether at least some of the one or more transactions correspond to recurring transfers to the particular one of the transfer targets.

In some implementations, determining that one or more transactions involving the particular one of the transfer targets corresponds to one or more transfers to the particular one of the transfer targets may include determining that two or more of the transactions correspond to recurring transfers to the particular one of the transfer targets. For example, determining that two or more of the transactions correspond to recurring transfers to the particular one of the transfer targets may include determining that the two or more of the transactions occurred at a recurring interval, that two or more of the transactions were of about the same amount, or that two or more of the transactions occurred on or about the same day of the month.

In some implementations, the location associated with the first account may be identified based on the transaction data.

In some implementations, the instructions, when executed by the processor, may further cause the computer system to: receive a signal representing an instruction to add the particular one of the transfer targets to the transfer interface; and responsive to receiving the signal representing the instruction to add the particular one of the transfer targets to the transfer interface, add the particular one of the transfer targets to the transfer interface. Further, in some implementations, the instructions, when executed by the processor, may further cause the computer system to: determine an account number based on the one or more transactions involving the particular one of the transfer targets. The account number may be used to add the particular one of the transfer targets to the transfer interface.

In some implementations, the one or more accounts may include at least one credit card account.

In some implementations, the transfer interface may be associated with a deposit account.

In some implementations, the transfer targets may correspond to billers, the transfers may correspond to bill payments, and/or the transfer interface may be or include a bill payment interface.

According to the subject matter of the present application, there may be provided a computer-implemented method. The method may include: identifying a location associated with a first account, the first account associated with an account holder; identifying a set of transfer targets associated with the identified location; identifying, by a processor, based on transaction data for one or more accounts associated with the account holder, transactions involving the transfer targets; determining, by the processor, that one or more transactions involving a particular one of the transfer targets correspond to one or more transfers to the particular one of the transfer targets; and generating a prompt for presentation by a client device to add the particular one of the transfer targets to a transfer interface.

In some implementations, determining that one or more transactions involving the particular one of the transfer targets corresponds to one or more transfers to the particular one of the transfer targets may include: computing a likelihood score based on the one or more transactions involving the particular one of the transfer targets, the likelihood score corresponding to a confidence that the one or more transactions correspond to one or more transfers to the particular one of the transfer targets; and comparing the likelihood score to a confidence threshold. For example, the likelihood score may be computed based on an evaluation of the one or more transactions according to one or more factors including a determination as to whether at least some of the one or more transactions correspond to recurring transfers to the particular one of the transfer targets.

In some implementations, determining that one or more transactions involving the particular one of the transfer targets corresponds to one or more transfers to the particular one of the transfer targets may include determining that two or more of the transactions correspond to recurring transfers to the particular one of the transfer targets. For example, determining that two or more of the transactions correspond to recurring transfers to the particular one of the transfer targets may include determining that the two or more of the transactions occurred at a recurring interval, that two or more of the transactions were of about the same amount, and/or that two or more of the transactions occurred on or about the same day of the month.

In some implementations, the location associated with the first account may be identified based on the transaction data.

In some implementations, the method may further include: receiving a signal representing an instruction to add the particular one of the transfer targets to the transfer interface; and responsive to receiving the signal representing the instruction to add the particular one of the transfer targets to the transfer interface, adding the particular one of the transfer targets to the transfer interface. Further, in some implementations, the method may further include: determining an account number based on the one or more transactions involving the particular one of the transfer targets. The account number may be used to add the particular one of the transfer targets to the transfer interface.

In some implementations, the transfer interface may be associated with a deposit account.

In some implementations, the transfer targets may correspond to billers, the transfers may correspond to bill payments, and/or the transfer interface may be or include a bill payment interface.

According to the subject matter of the present application, there may be provided a computer-readable medium storing instructions that, when executed by a processor of a computer system cause the computer system to perform the above-described method. In some implementations, the computer-readable medium may be a non-transitory computer-readable storage medium.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

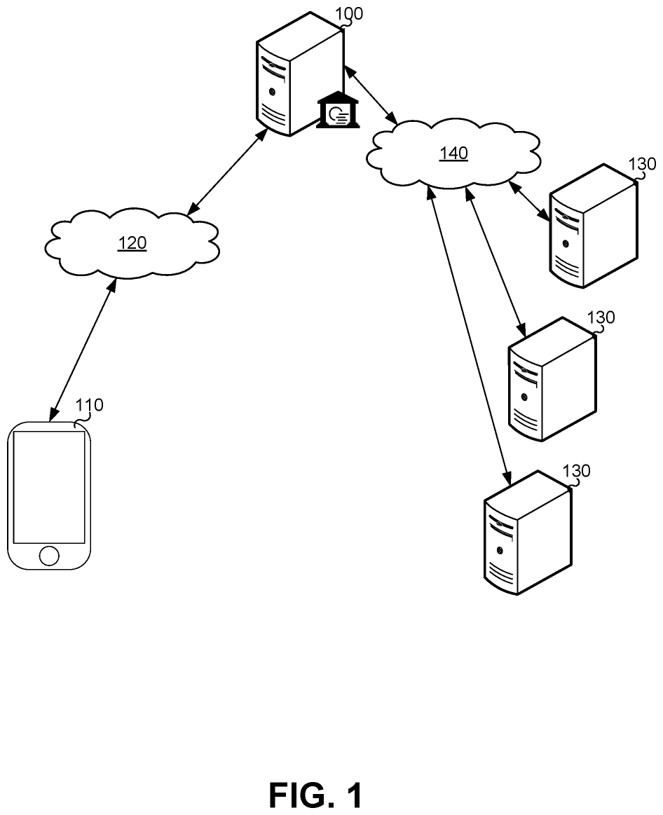

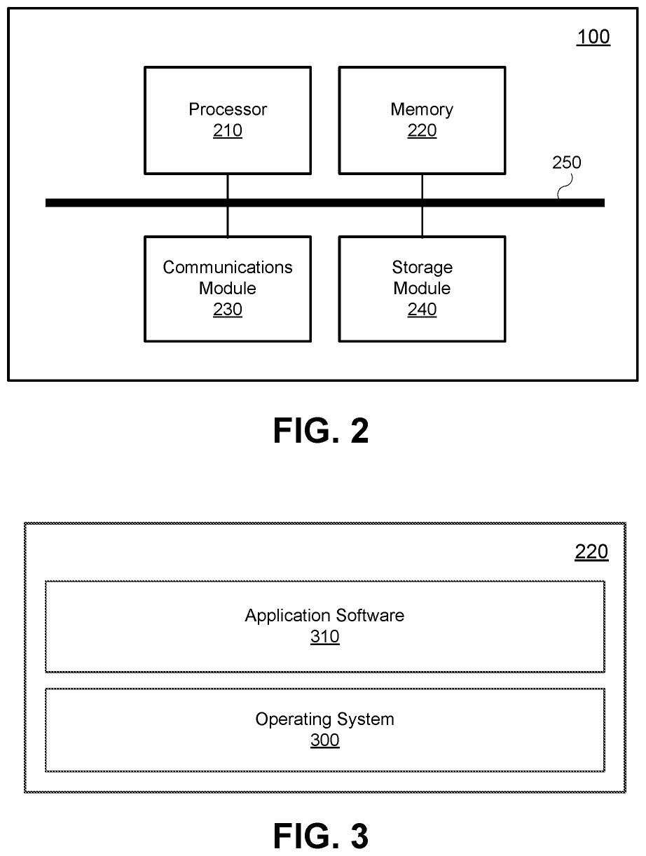

FIG. 1 is a schematic operation diagram illustrating an operating environment of an example embodiment.

As illustrated, a transaction server computer system 100 and a mobile computer system 110 are in communication via a first network 120. Further, the transaction server computer system 100 is in communication with a set of additional computer systems 130 via a second network 140.

The transaction server computer system 100 and the various ones of the additional computer systems 130 are computer servers. Such computer systems may, for example, be a mainframe computer, a minicomputer, or the like. In some implementations thereof, a computer server system may be formed of or may include one or more computing devices. A computer server system may include and/or may communicate with multiple computing devices such as, for example, database servers, compute servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

As further described below, the transaction server computer system 100 is employed in processing of transactions. That is to say, the transaction server computer system 100 provides and/or is associated with a transaction processing system. For example, one or more accounts may be associated with the transaction server computer system 100 and the transaction server computer system 100 may be employed in processing transactions related thereto. More particularly, the transaction server computer system 100 may be employed in processing transactions including transactions corresponding to transfers to and/or from one or more of those accounts. In some implementations, the transaction server computer system 100 may process transactions directly. Additionally or alternatively, the transaction server computer system 100 may co-operate with one or more other computer systems in processing transactions. For example, the transaction server computer system 100 may co-operate with various of the additional computer systems 130 in processing transactions.

The mobile computer system 110 is a mobile computing device. It may, as illustrated, be a smart phone. However, in some embodiments, the mobile computer system 110 may be a computing device of another type such as, for example, a personal computer, a smart speaker, a laptop computer, a tablet computer, a notebook computer, a hand-held computer, a personal digital assistant, a portable navigation device, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The mobile computer system 110 may allow a user to interact with the transaction server computer system 100. For example, the transaction server computer system 100 may provide a user interface for initiating or controlling transfers processed via the transaction server computer system 100.

The additional computer systems 130 may also be involved in the processing of transactions. In some cases, some or all of the additional computer systems 130 may be involved in processing transactions unrelated to those processed by the transaction server computer system 100. Additionally or alternatively, some or all of the additional computer systems 130 may co-operate with the transaction server computer system 100 in processing transactions. Notably, some or all of the transactions in which the additional computer systems 130 co-operate in processing may correspond to transfers between various accounts. Transfers involving the transaction server computer system 100 and one or more of the additional computer systems 130 may be variously initiated by the transaction server computer system 100 and/or one or more of the additional computer systems 130.

The first network 120 and the second network 140 are computer networks. In some embodiments, either or both may be an internetwork such as may be formed of one or more interconnected computer networks. For example, one or both of the first network 120 and the second network 140 may be or may include an Ethernet network, an asynchronous transfer mode (ATM) network, a wireless network, or the like. It may be that the first network 120 and the second network 140 are separate, disparate networks. Alternatively, it may be that the first network 120 and the second network 140 are the same network.

Some or all of the transaction server computer system 100, the mobile computer system 110, and the additional computer systems 130 may be in locations geographically disparate from others of the transaction server computer system 100, the mobile computer system 110 and the additional computer systems 130. Put differently, some or all of the transaction server computer system 100, the mobile computer system 110, and the additional computer systems 130 may be remote from others of the transaction server computer system 100, mobile computer system 110, and the additional computer systems 130. Furthermore, some or all of the computer systems of the additional computer systems 130 may be remote from others of the additional computer systems 130.

As further described below, the transaction server computer system 100 may automatically detect transactions corresponding to transfers to various transfer targets based on transaction data. In doing so, the transaction server computer system 100 may co-operate with the additional computer systems 130 via the second network 140. For example, some or all of the transaction data analyzed by the transaction server computer system 100 in identifying transfer targets may be provided by one or more of the additional computer systems 130.

Additionally or alternatively, the transaction server computer system 100 and the mobile computer system 110 may co-operate via the first network 120 in relation to the configuration and initiation of transfers. For example, the mobile computer system 110 may co-operate with the transaction server computer system 100 to obtain confirmation that the transaction system should be configured to add an identified transfer target.

Notably, in some implementations, the transaction processing system provided by and/or associated with the transaction server computer system 100 may be a financial transaction processing system. In some such implementations, the transaction server computer system 100 may be a computer system related to a financial institution such as, for example, a bank. In some such implementations, the additional computer systems 130 may also be involved in the processing of the financial systems. For example, some or all of the additional computer systems 130 may correspond to one or more other entities involved in the processing of financial transactions (e.g., transactions associated with financial accounts and/or services). In a particular example, some of all of the additional computer systems 130 may be associated with one or more payment processors and/or one or more payment accounts or cards such as, for example, bank accounts and/or credit cards. Notably, where the transaction server computer system 100 is involved in the processing of financial transactions, some or all of the aforementioned transfers may correspond to payment transfers. For example, some or all of the transfers may correspond to bill payments to one or more billers. As mentioned above, the mobile computer system 110 may be employed in initiating and/or controlling transfers. For example, the mobile computer system 110 may be used in initiate and/or control payment transactions such as, for example, bill payments. In a particular example, the mobile computer system 110 may be used to initiate and/or control payment transactions in association with one or more accounts of a financial institution such as, for example, where the transaction server computer system 100 is associated with that financial institution. The mobile computer system 110 may be executing an application related to the financial institution such as, for example, a mobile banking application (mobile banking “app”).

FIG. 3 is a high-level schematic diagram of the transaction server computer system 100.

The transaction server computer system 100 includes a variety of modules. For example, as illustrated, the transaction server computer system 100 may include a processor 210, a memory 220, a communications module 230, and/or a storage module 240. As illustrated, the foregoing example modules of the transaction server computer system 100 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the transaction server computer system 100.

The communications module 230 allows the transaction server computer system 100 to communicate with other computing devices and/or various communications networks such as, for example, the first network 120 and/or the second network 140. The communications module 230 may allow the transaction server computer system 100 to send or receive communications signals. Communications signals may be sent or received according to one or more protocols or according to one or more standards. For example, the communications module 230 may allow the transaction server computer system 100 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the transaction server computer system 100 to communicate via Wi-Fi™, using Bluetooth™ or via some combination of one or more networks or protocols. In some embodiments, all or a portion of the communications module 230 may be integrated into a component of the transaction server computer system 100. For example, the communications module may be integrated into a communications chipset.

The storage module 240 allows the transaction server computer system 100 to store and retrieve data. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the transaction server computer system 100. As illustrated, these software components include an operating system 300 and an application software 310.

The operating system 300 is software. The operating system 300 allows the application software 310 to access the processor 210, the memory 220, the communications module 230, and the storage module 240 of the transaction server computer system 100. The operating system 300 may be, for example, UNIX™, Linux™, Microsoft™ Windows™, Apple OSX™ or the like.

The application software 310 may adapt the transaction server computer system 100 for use in/as a transaction processing system. For example, the application software 310 may adapt the transaction server computer system 100 for automatic configuration of the transaction processing system to allow transfers to be made to various transfer targets detected as being involved in analyzed transactions.

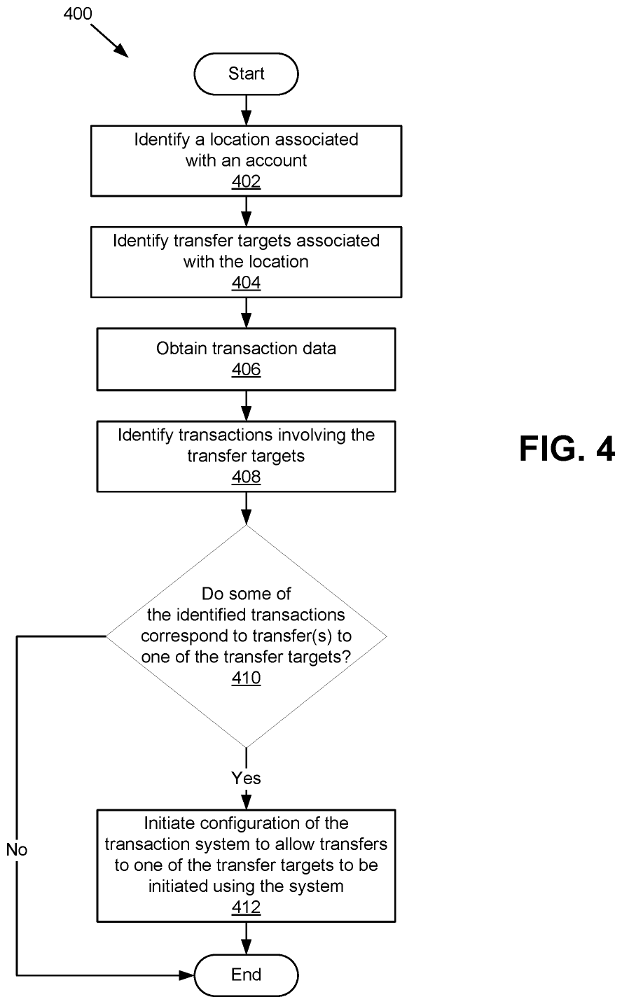

The operation of the transaction server computer system 100 will now be described with reference to the flowchart of FIG. 4 which illustrates a method 400 for providing automatically identifying and configuring transfer targets. In performing the method 400, operations starting from an operation 402 and continuing onward are performed by the processor 210 (FIG. 3) of the transaction server computer system 100 executing instructions such as, for example, from the memory 220. In a particular example, some or all of the operations may be performed by the processor 210 of the transaction server computer system 100 executing software such as, for example, a suitable instance of the application software 310 (FIG. 3).

As mentioned above, the transaction server computer system 100 may be employed in processing transactions in relation to one or more accounts. For example, the transaction server computer system 100 may store and/or process transactions related to one or more profiles, each of those profiles being associated with one or more individuals and/or entities and one or more accounts. Notably, the individual(s) and/or entity/entities associated with a particular profile may be an/the account holder (e.g., owner) of all or some of the accounts associated with that profile.

At the operation 402, at least one location associated with an account is identified. The location(s) may be identified in a variety of manners.

The location(s) may, for example, be identified based on a mailing address associated with the account. Additionally or alternatively, the location(s) may be determined based on an address or addresses associated with a profile with which the account is associated. In another example, the location(s) may, additionally or alternatively, be identified based on analysis of transactions associated with the account such as, for example, transactions in the account. Additionally or alternatively, transactions associated with another account associated with the same profile may be analyzed. Transactions may be analyzed to identify location data. For example, where the received transaction data corresponds to financial transactions, one or more locations may be identified based on transaction location information for transactions included in the obtained transaction data. In a particular example, where some or all the transactions correspond to payment transactions, merchant data associated with some or all of the payment transactions may be analyzed to extract any merchant location information. Based on the merchant location data, one or more locations may be identified. For example, locations of recent transactions and/or locations appearing at a high frequency in the location data may be identified.

However the location is or locations are identified, following identification thereof at the operation 402, an operation 404 is next.

At the operation 404, a set of candidate transfer targets are identified. For example, transfer targets associated with the location(s) identified at the operation 402 may be identified. Notably, where the transfer targets correspond to billers, the identified transfer targets may, for example, be common billers (“top” billers) in a given geographic area. Common or top billers are billers that already receive a lot of bill payments in that area such as, for example, from other customers of a financial institution such as may be associated with the transaction server computer system 100.

Transfer targets associated with a location may be identified in a variety of manners. For example, it may be that a lookup table of known locations and known transfer targets is maintained in storage such as, for example, in one or more of the memory 220, storage accessible using the storage module 240, and/or some remote storage such as may be accessed using the communications module 230 such as, for example, a remote database. Additionally or alternatively, such storage may maintain a list of known transfer targets and locations associated therewith, and the list of transfer targets may be composed via a suitable query such as, for example, a database query, executed over that data.

Where the transfers correspond to payment transactions, the transfer targets associated with a location may correspond to merchants in that location and/or the vicinity thereof. For example, it could be that the transfer targets are common billers in a given area and that some or all of the transactions corresponding to transfers found in an account associated with a location in or about that area may correspond to bill payments to some or all of those billers. In a particular example, the transfer targets associated with a location may be local utilities such as, for example, electric, water, sewer, cable, and/or telephone/cellphone providers.

Following the identification of transfer targets at the operation 404, an operation 406 is next.

At the operation 406, transaction data is obtained. The transaction data may correspond to historical transactions. For example, the transaction data may correspond to transactions as occurred within a defined window and/or period. The transaction data may come from a variety of sources. For example, the transaction data may be drawn from the account discussed above in relation to the operation 402. Additionally or alternatively, the transaction data may be associated with one or more other accounts. For example, transaction data may be obtained for one or more accounts associated with the account holder of the aforementioned account. In a particular example, the accounts may include one or more other accounts associated with the same profile as the aforementioned account.

In some cases, transaction data may be received from one or more remote servers. For example, transaction data may be received from some or all of the additional computer systems 130 such as, for example, via the second network 140 (e.g., using the communications module 230). The remote servers may include computer systems associated with a variety of transaction sources. For example, the transactions may be financial transactions and the transaction data may correspond to particular accounts and/or payment methods. In such embodiments, some or all of the remote servers (e.g., some or all of the computer servers of the additional computer systems 130), may be associated with particular payment methods, payment types, and/or financial institutions. For example, transactions data may relate to different accounts such as, for example, credit card accounts of various types, deposit accounts with various financial institutions, etc. In a particular example, accounts from for which transaction data is obtained may include at least one (i.e., one or more) credit card accounts. Additionally or alternatively, where the transaction data is for financial transactions, some or all of the remote servers providing transactions may be associated with and/or may obtain data from a financial data aggregator and/or provider of unified bank account data APIs such as, for example, Yodlee, Inc. of Redwood City, Calif., USA or Plaid Inc. of San Francisco, Calif., USA. Notably, remote servers including, for example, those associated with such an aggregator and/or provider, may provide access to information related to accounts associated with more than one financial institution/financial services provider such as, for example, a financial institution other than that as may be associated with the transaction server computer system 100.

Following the operation 406, an operation 408 is next.

Notably, a variety of different transactions may be included in the transaction data and not all of the transactions included in the transaction data will be transfers, let alone transfers involving one of the identified transfer targets. For example, where the transaction data corresponds to financial transactions, a variety of different types of transactions (e.g., point-of-sale transactions, bill payments, automated teller machine (ATM) withdrawals, check deposits, check payments, etc.) may be included, not all which will may be considered to be/correspond to transfers let alone transfers to one of the identified transfer targets.

Following the operation 406, at the operation 408, transactions involving transfer targets are identified. More particularly, transactions involving the transfer targets that were identified at the operation 404 (i.e., the transaction targets associated with the location identified at the operation 402) are identified.

Transactions involving the identified transfer targets may be identified in a variety of manners. For example, metadata associated with transactions such as, for example, merchant names, account numbers, or the like may be compared to metadata known to be associated with a particular one of the transfer targets. Transactions having metadata matching (or partially matching on enough points to satisfied a required confidence) known metadata associated with a particular transfer target may be identified as involving the transfer target.

Following the identification of transactions involving one or more of the transfer targets at the operation 408, an operation 410 is next.

At the operation 410, it is determined whether any of the identified transactions correspond to transfers to the associated transfer targets. For example, where the transactions are financial transactions, it may be determined whether some or all of the transfers associated with a given transfer target correspond to transfers to that transfer target.

Determining whether transactions involving a given transfer target correspond to one or more transfers involving that transfer target may be performed in a variety of manners.

In some implementations, data or metadata associated with transactions may be evaluated to determine whether one or more of the transactions correspond to one or more transfers to a given transfer target. For example, where the transactions are financial transactions, the data and/or metadata considered may include, for example, merchant names, account numbers, amounts, dates, etc. In a particular example, transactions involving one of the identified transfer targets and having an associated amount exceeding a threshold (or a threshold for a given transfer target) may be identified as corresponding to transfers to transfer targets.

In some cases, data or metadata associated with transactions may be assessed to arrive at a likelihood score for (i.e., corresponding to) a given transaction and/or group of transactions indicating a likelihood that that/those transaction(s) correspond to a transfer to a given transfer target. Those likelihood scores (which may also be referred to as confidence scores) may then be assessed by the transaction server computer system 100 to determine whether or not to consider any of those transactions to correspond to transfers. For example, it may be that such a score is compared to a confidence threshold such that scores exceeding (and, potentially, equaling) that threshold value are considered to correspond to a transfer.

In some implementations, some or all of the transactions involving a particular transfer that are identified as corresponding to transfer(s) to that transfer target, may be transfers that are identified as corresponding to/being likely to correspond to a recurring transfer. For example, in the case that the transaction data corresponds to financial transactions, recurring transfers may correspond to identification of recurring payments. Notably, recurring payments may be likely to correspond to bill payments (e.g., for services that are billed on a periodic/recurring basis) and so, if the transfer targets identified as associated with a given location correspond to billers and, more particularly, to known billers in a geographic area, identifying apparent recurring transfers to those transfer targets may allow bill payments to be identified with a good degree of confidence. Indeed, many common bills (e.g., cell phone, electricity, internet, etc.) are often billed and paid on a recurring or periodic basis.

Whether or not they correspond to financial transactions, transactions or a set of transactions may be evaluated to determine whether they appear to correspond to recurring transfers to a given transfer target in a variety of manners. Notably, more than one of the transactions involving a given transfer target could be considered together to determine whether that data is consistent with a recurring transfer. For example, transactions could be considered together to see if transactions at relatively constant intervals and/or of relatively consistent amounts can be identified (i.e., if such transactions occur at a recurring interval). Notably, transactions involving a given transfer target that occur at relatively constant intervals and/or each time on the same or about the same day of the month may correspond to recurring transfers. As such, if two or more of the transactions involving a given transfer target occurred on or about the same day of the month, it may be considered indicative that those transactions correspond to recurring transfers involving that transfer target. In another example, where the transactions have associated amounts (e.g., a currency amount in the case of financial transactions), repeated transactions of the same amount or similar amounts (i.e., transactions of about the same amount plus or minus some absolute number of dollars or varying by less than some percentage) may be considered as an indication that those transactions correspond to recurring transfers.

In some cases, not only may more than one transaction be considered in tandem, but also more than one of such factors potentially indicative of a recurring transfer may be considered in tandem. For example, multiple transactions involving a given transfer target may be assessed and then a confidence score as discussed above could be assigned identifying a likelihood that those ones of the transactions appear to correspond to a recurring payment. In a particular example, a higher confidence score could be assigned where the number of heuristics for identifying transactions correspond to recurring transfers that are satisfied is higher. Additionally or alternatively, such a score may be determined based on an aggregation of likelihoods/confidence values associated with the matching of each of the various factors/heuristics being employed. However arrived at, the confidence score may be evaluated to determine whether or not the considered transactions are to be considered consistent with and/or to appear to be recurring transfers, such as, for example, by comparison to a threshold confidence value as discussed above. In summary, it may be that a confidence expressing a likelihood that one or more transactions involving a given transfer target correspond to transfers to that transfer target may be computed based on an evaluation of transactions involving that transfer target according to one or more factors including, for example, a determination as to whether at least some of those transactions correspond to recurring transfers.

If it is determined at the operation 410 that none of the transactions identified at the operation 408 correspond to transfers to one of the transfer targets, the method terminates.

Alternatively, if it is determined that, for at least a particular one of the transfer targets, one or more of the transactions involving the particular one of the transfer targets correspond to transfers to one or more to the particular one of the transfer targets, an operation 412 is next. Notably, the particular one of the transfer targets may be a transfer target for which the transaction system is not yet configured to allow transfers to that transfer target to be initiated using the transaction system.

At the operation 412, the transaction system is configured to allow transfers to the transfer targets identified at the operation 412 to be initiated using the transaction server computer system 100 and, more particularly, using the transaction processing system associated therewith.

Initiation of such configuration may involve a variety of sub-operations, depending on the implementation and the circumstances.

For example, in some implementations, a transfer interface may be provided. Such an interface may, for example, allow the configuration and initiation of transfers to be effected via the transaction processing system. For example, where the transaction processing system is a financial transaction processing system, the transfers may be or include monetary transfers such as, for example, bill payments. In some such implementations, a transfer interface may be provided allowing for configuration and initiation of bill payments. Put another way, a bill payment interface may be provided such as, for example, as a part of a bill payment interface associated with a financial account such as, for example, a chequing account. Whatever the form of transfer interface, it may be that configuring of the transaction system to allow transfers to the identified transfer targets to be initiated includes addition of the transfer targets to a list of available transfer targets from amongst which transfer targets are selected when initiating and/or configuring transfers. For example, where the transfer interface corresponds to/includes a bill payment interface, configuring to allow transfers to an identified transfer target may include the addition of that transfer target to a list of available billers/payees.

A transaction interface may be provided by another computing device in cooperation with the transaction server computer system 100. For example, it may be that, as mentioned above, the transaction server computer system 100 and the mobile computer system 110 co-operate via the first network 120 in relation to the configuration and initiation of transfers. In some such implementations, a user interface corresponding to a transfer interface may be provided by the mobile computer system 110 for configuration and initiation of transfers in co-operation with the transaction server computer system 100. For example, the mobile computer system 110 may provide a bill payment interface allowing bill payments to be initiated using the mobile computer system 110 and which will then be effected using the transaction processing system through the co-operation of the transaction server computer system 100. In a particular example, the mobile computer system 110 may execute instructions corresponding to an online banking application (e.g., a banking app) and may present a user interface and receive user input so as to provide a transfer interface for making financial transfers (e.g., bill payments) in co-operation with the transaction server computer system 100.

In some implementations, the user interface of a transfer interface may present the identified transfer targets as suggestions for addition to a list of available transfer targets. For example, in the case where the transfer interface corresponds to/includes a bill payment interface, the identified transfer targets may be presented as possible billers/payees to add to a list of available billers to which bill payments may be made. Whatever the nature of the transfers, it may be that a prompt is generated on and/or for presentation by a client device such as, for example, the mobile computer system 110 related to one or more suggested transfer targets (some or all of the identified transfer targets), the prompt being a prompt to add a transfer target to the transfer interface. Put another way, the user interface may present one or more suggestions of possible transfer targets to be configured for use with the transfer interface. Once one or more of the identified transfer targets are presented, some or all of the presented transfer targets may be added to the transfer interface. For example, transfer targets may be added to the transfer interface in response to input received responsive to suggestions. In a particular example, for a particular one of the transfer targets, a signal may be received representing an instruction to add the particular one of the transfer targets to a transfer interface. Such an instruction may, for example, correspond to user input accepting a suggested transfer target. Whatever the form of the instruction, responsive to receiving the signal representing the instruction to add the particular one of the transfer targets to the transfer interface, the particular one of the transfer targets may be added to the transfer interface.

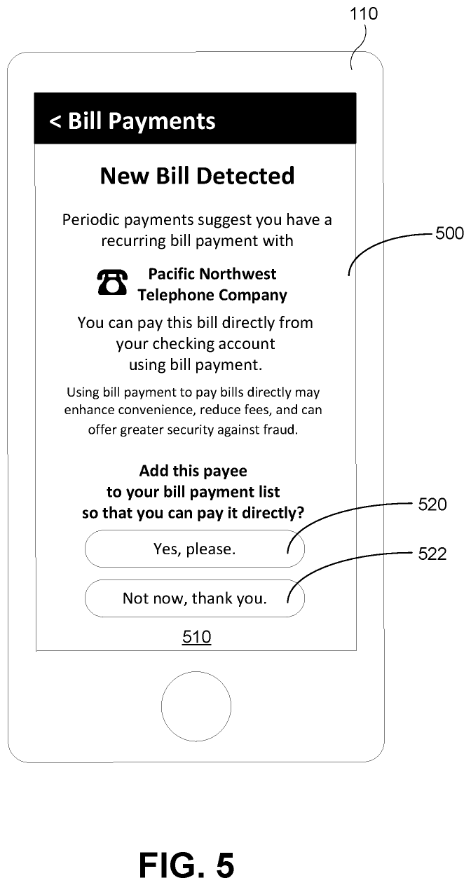

An example of a possible user interface for presenting a suggestion to add a particular transfer target to a bill payment interface is provided in FIG. 5.

As illustrated, a display 500 of the mobile computer system 110 displays a user interface 510. The user interface 510 includes explanatory text setting out information related to an identified transfer target (“Pacific Northwest Telephone Company”) and offers to add that identified target as a biller by adding it to a bill payment list associated with the bill payment transfer interface. In particular, a first button 520 is provided that a user may select (e.g., via touch input to the display 500 where it is a touchscreen) to add the transfer target as a biller. Additionally, a second button 522 is provided that a user may select to decline the addition of the transfer target as a biller. Notably, in this way, the transaction system may be selectively configured to allow transfers to a given one of the transfer targets to be initiated using the transaction system and, in particular, using the transfer interface. For example, in this way, in the illustrated example, the transaction processing system associated with the transaction server computer system 100 may be configured to allow it to be used to initiate a bill payment to the Pacific Northwest Telephone Company.

Notably, suggestions and/or confirmations may only be presented for transfer targets that have not already been added for to a transfer interface. For example, the list of identified targets could be filtered to remove transfer targets previously added to a transfer interface so that only some or all of the remaining targets are presented as suggestions for addition and/or for confirmation. In a particular example, where the transfer targets correspond to billers, a given transfer target may only be presented if does not match a previously-configured biller (e.g., previously-configured billers may be filtered so as to not be included in a list of suggested billers.)

The addition of a transfer target to a transfer interface may involve one or more operations. For example, it may be that one or more parameters related to the transfer target require configuration. For example, where the transfer target corresponds to a biller, account information associated with an account must be provided. In some implementations, user interface may be utilized to prompt a user to provide such information. Additionally or alternatively, some or all of such information may be identified automatically by the transaction server computer system 100. For example, it may be that transactions involving that transfer target (e.g., previous transfers to the transfer target) are analyzed to identify such information. In a particular example, where the transactions are financial transactions, information such as, for example, an account number may be identified based on the previously-identified transactions involving a given one of the transfer targets and that account number may be used to add that one of the transfer targets to a transfer interface such as, for example, to add the transfer target to a bill payment interface as a biller. In a particular example, an account number may be extracted from metadata associated with a transaction such as, for example, an Automated Clearing House (ACH) withdrawal from a US bank account and/or an Electronic Funds Transfer (EFT) withdrawal from a Canadian bank account.

In some implementations, one or more such transfer targets could be presented in succession using an interface such as the user interface 510 so as to present a series of suggested transfer targets. Alternatively, it could be that a single transfer target is selected such as, for example, an identified transfer target having a highest associated likelihood/confidence. Conveniently, by limiting the number of transfer targets presented (such as, for example, based on confidence), the system may avoid or limit user annoyance from repeated or spurious suggestions.

The method 400 is presented by way of example and is capable of variation without departing from the subject matter of the present application. For example, in some implementations, some or all the transaction data received at the operation 406 may, additionally or alternatively, be received earlier in the method and could, for example, be employed to further ends such as, for example, by employing some or all of it in the identification of locations at the operation 402.

Notably, allowing transfer targets to be identified and configured for use with transaction system (e.g., using a transfer interface associated with the transaction system) so as to allow transfers to those transfer targets to be initiated using the transaction system (e.g., using the transfer interface) in manners consistent with the present application may provide one or more of a variety of advantages. For example, in the case that identified transfers correspond to bill payments not being initiated using the bill payment functionality provided by a financial institution in association with an account thereof (e.g., bill payments not made/initiated using a bill payment feature of a checking account), the subject matter of the present application may allow a user to more easily transition to using that bill payment functionality to initiate bill payments directly from their account. Notably, in the case of bill payments, initiation of payments from other sources may be associated with a variety of disadvantages as compared to initiation of bill payments directly from a bill payment interface of a bank account. For example, to initiate bill payments elsewhere, customers may need to provide the biller with information so that the biller may then, for example, initiate an Automated Clearing House (ACH) (in USA) and/or Electronic Funds Transfer (EFT) (in Canada) transaction to “pull” funds from the account. Put another way, in some cases, to allow a bill payment to be initiated from outside the transaction system associated with a customer's bank account, a customer may authorize a biller to make a pre-authorized withdrawal from their bank account. Typically, to configure such pre-authorized withdrawals, a biller must be provided with banking information such as, for example, a name of a financial institution, an account type (e.g., checking or savings), a routing number (e.g., an ABA routing number) and/or an account number. Alternatively, customers may provide a biller with credit card information to allow the biller to automatically process a payment via a credit card. Notably, whatever the nature of the provided financial information, where customers configure such “pull” payments with multiple billers, there may be a risk that at least some of that information could be compromised through, for example, a compromise of systems of any one of the billers. Furthermore, because such payments are tied to a given account (e.g., a given bank or credit card account), customers are denied the ability to selectively pay from different accounts and/or using different methods. Moreover, if a user wishes to and/or has to make a change in their payment information (e.g. to change the account the bill will be drawn from and/or to provided updated information such as, for example, a new credit card expiration date), it may be difficult and/or burdensome if such information is maintained by multiple billers due to the need to contact each biller individually to provide new information. More broadly, any “pull” of account may result in a loss of control for a customer. For example, a biller could draw a payment to satisfy a bill that is in dispute by a customer. Notably, a customer may avoid some or all of the aforementioned disadvantages by transitioning to use of bill payment functionality whereby bill payments are initiated using a bill payment interface of a financial institution account and the subject-matter of the present application may serve to facilitate and/or ease such a transition.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer system comprising:
a processor; and
a memory coupled to the processor and storing instructions that, when executed by the processor, cause the computer system to:
identify a location associated with a first account, the first account associated with an account holder;
identify a set of transfer targets associated with the identified location;
identify, based on transaction data for one or more accounts associated with the account holder, transactions involving the transfer targets;
determine that one or more transactions involving a particular one of the transfer targets correspond to one or more transfers to the particular one of the transfer targets; and
generate a prompt for presentation by a client device to add the particular one of the transfer targets to a transfer interface.

2. The computer system of claim 1, wherein determining that one or more transactions involving the particular one of the transfer targets corresponds to one or more transfers to the particular one of the transfer targets includes:
computing a likelihood score based on the one or more transactions involving the particular one of the transfer targets, the likelihood score corresponding to a confidence that the one or more transactions correspond to one or more transfers to the particular one of the transfer targets; and
comparing the likelihood score to a confidence threshold.

3. The computer system of claim 2, wherein the likelihood score is computed based on an evaluation of the one or more transactions according to one or more factors including a determination as to whether at least some of the one or more transactions correspond to recurring transfers to the particular one of the transfer targets.

4. The computer system of claim 1, wherein determining that one or more transactions involving the particular one of the transfer targets corresponds to one or more transfers to the particular one of the transfer targets includes determining that two or more of the transactions correspond to recurring transfers to the particular one of the transfer targets.

5. The computer system of claim 4, wherein determining that two or more of the transactions correspond to recurring transfers to the particular one of the transfer targets includes determining that the two or more of the transactions occurred at a recurring interval, that two or more of the transactions were of about the same amount, or that two or more of the transactions occurred on or about the same day of the month.

6. The computer system of claim 1, wherein the location associated with the first account is identified based on the transaction data.

7. The computer system of claim 1, wherein the instructions, when executed by the processor, further cause the computer system to:
receive a signal representing an instruction to add the particular one of the transfer targets to the transfer interface; and
responsive to receiving the signal representing the instruction to add the particular one of the transfer targets to the transfer interface, add the particular one of the transfer targets to the transfer interface.

8. The computer system of claim 7, wherein the instructions, when executed by the processor, further cause the computer system to:
determine an account number based on the one or more transactions involving the particular one of the transfer targets, wherein the account number is used to add the particular one of the transfer targets to the transfer interface.

9. The computer system of claim 1 wherein the one or more accounts include at least one credit card account.

10. The computer system of claim 1 wherein the transfer interface is associated with a deposit account.

11. The computer system of claim 1 wherein the transfer targets correspond to billers, the transfers correspond to bill payments, and the transfer interface includes a bill payment interface.

12. A computer-implemented method comprising:
identifying a location associated with a first account, the first account associated with an account holder;
identifying a set of transfer targets associated with the identified location;
identifying, by a processor, based on transaction data for one or more accounts associated with the account holder, transactions involving the transfer targets;
determining, by the processor, that one or more transactions involving a particular one of the transfer targets correspond to one or more transfers to the particular one of the transfer targets; and
generating a prompt for presentation by a client device to add the particular one of the transfer targets to a transfer interface.

13. The method of claim 12, wherein determining that one or more transactions involving the particular one of the transfer targets corresponds to one or more transfers to the particular one of the transfer targets includes:
computing a likelihood score based on the one or more transactions involving the particular one of the transfer targets, the likelihood score corresponding to a confidence that the one or more transactions correspond to one or more transfers to the particular one of the transfer targets; and
comparing the likelihood score to a confidence threshold.

14. The method of claim 13, wherein the likelihood score is computed based on an evaluation of the one or more transactions according to one or more factors including a determination as to whether at least some of the one or more transactions correspond to recurring transfers to the particular one of the transfer targets.

15. The method of claim 12, wherein determining that one or more transactions involving the particular one of the transfer targets corresponds to one or more transfers to the particular one of the transfer targets includes determining that two or more of the transactions correspond to recurring transfers to the particular one of the transfer targets.

16. The method of claim 15, wherein determining that two or more of the transactions correspond to recurring transfers to the particular one of the transfer targets includes determining that the two or more of the transactions occurred at a recurring interval, that two or more of the transactions were of about the same amount, or that two or more of the transactions occurred on or about the same day of the month.

17. The method of claim 12, wherein the location associated with the first account is identified based on the transaction data.

18. The method of claim 12, further comprising:
receiving a signal representing an instruction to add the particular one of the transfer targets to the transfer interface; and
responsive to receiving the signal representing the instruction to add the particular one of the transfer targets to the transfer interface, adding the particular one of the transfer targets to the transfer interface.

19. The method if claim 18, further comprising:
determining an account number based on the one or more transactions involving the particular one of the transfer targets, wherein the account number is used to add the particular one of the transfer targets to the transfer interface.

20. The method of claim 12 wherein the transfer interface is associated with a deposit account.
